(19) United States
(12) Patent Application Publication
(10) Pub. No.: US 2006/0278628 A1
(43) Pub. Date: Dec. 14, 2006

(54) Heated inflatable air bed

(76) Inventors: James A. Foggett, Land O' Lakes, FL (US); Christopher James Foggett, Holiday, FL (US)

Correspondence Address: LARSON AND LARSON, 11199 69TH STREET NORTH, LARGO, FL, 33773, US

(21) Appl. No.: 11/148,059

(22) Filed: Jun. 8, 2005

(51) Int. Cl. H05B 3/00

(52) U.S. Cl. 219/217; 5/706; 5/421

(57) ABSTRACT

A top vinyl layer, a bottom vinyl layer and a side vinyl layer are all heat welded together along peripheral edges forming a mattress. A cloth cover has a heating pad removably attached to at least two of its peripheral edges and the cloth cover is removably attached at is peripheral edges to a top peripheral edge of the mattress.

### BACKGROUND OF THE INVENTION

1. Field of the Invention

The invention relates to inflatable air beds. More specifically, it refers to an air bed having vinyl layers enclosing an inflatable air space and a cloth cover and a heating pad removably attached together along exterior edges.

2. Background of the Invention

Mattresses containing a heating unit are well known as shown in Reissue Pat. No. 22,763; U.S. Pat. Nos. 2,606,996; 4,162,393; 4,388,738; 4,423,308; 5,787,525 and 5,881,410.

The heating of a mattress is a desirable condition, particularly in cold climates. For this reason, many popular heated mattress designs have been developed. Vinyl layers typically employed over inflatable air mattresses are difficult to heat and improved ways to achieve such heating are sought. A heated inflatable air bed is described in U.S. Pat. No. 6,839,922 to Foggett, et al., issued Jan. 11, 2005 and is hereby incorporated by reference. The prior art integrates an electric heating pad onto the top surface of the mattress, then provides for a cloth cover layer to add comfort and heat distribution. Unfortunately, if the heating pads have a potential to fail either in manufacture or during use, it cannot be removed. One potential factor in failure of the heating pads is inductive current emitted by the vinyl welding process. The vinyl welding process uses a high current element along the length of the vinyl weld, a by-product of which is an electromagnetic field (EMF). The EMF induces current flow in the heating pads, potentially causing failure of the heating pads. Also, if the cloth cover layer becomes soiled, it is difficult to clean.

What is needed is a heated air bed that will permit installation of the heating pad after the welding process is complete and will permit the removal of the heating pad and/or the cloth cover for repair and/or cleaning.

### SUMMARY OF THE INVENTION

In one embodiment, a heated inflatable air bed is disclosed including a top vinyl layer with a peripheral edge, a bottom vinyl layer with a peripheral edge and a side gusset vinyl layer with a top and bottom peripheral edge. The peripheral edge of the top vinyl layer is welded to the top peripheral edge of the side gusset vinyl layer leaving an extension consisting of a section of at least one of the peripheral edge of the top vinyl layer and the top peripheral edge of the side gusset layer extending beyond the weld where a first edge of a connector is affixed. A heating pad with a cloth cover and a peripheral edge is affixed to a second edge of the connector. The peripheral edge of the bottom vinyl layer is welded to the bottom peripheral edge of the side gusset vinyl layer forming an air chamber and there is a way to insert air into the air chamber penetrating a portion of the vinyl layers.

In another embodiment, a heated inflatable air bed is disclosed including a top vinyl layer with a peripheral edge, a bottom vinyl layer with a peripheral edge and a side gusset vinyl layer with a top and bottom peripheral edge. The peripheral edge of the top vinyl layer is welded to the top peripheral edge of the side gusset vinyl layer and an extension extends beyond the weld consisting of a section of at least one of the peripheral edge of the top vinyl layer and the top peripheral edge of the side gusset layer where a first edge of a connector is affixed. A second edge of the connector is affixed to the peripheral edge of a cloth cover. The connector is capable of multiple connecting and disconnecting cycles. A heating pad is situated between the cloth cover and the top vinyl layer. The peripheral edge of the bottom vinyl layer is welded to the bottom peripheral edge of the side gusset vinyl layer creating an air chamber and there is a way to allow air into the air chamber penetrating a portion of the vinyl layers.

In another embodiment, a method for making the mattress is disclosed including providing a top and a bottom vinyl layer with peripheral edges, providing a gusset vinyl layer with a top and bottom peripheral edge and welding the top peripheral edge of the gusset vinyl layer to the peripheral edge of the top vinyl layer leaving an extension consisting of at least one of the top peripheral edge of the gusset vinyl layer and the peripheral edge of the top vinyl layer. The bottom peripheral edge of the gusset vinyl layer is welded to the peripheral edge of the bottom vinyl layer so as to enclose an air chamber. A cloth cover with an internal electrical heating pad has a peripheral edge and is stitched to a second edge of a connector. A first edge of the connector is stitched to the extension. A way to support the air bed when inflated between the top and bottom vinyl layers is provided and a way to conduct air to and from the air chamber is provided.

In another embodiment, a method for making the mattress is disclosed including providing a top and a bottom vinyl layer with a peripheral edge, providing a gusset vinyl layer with a top and bottom peripheral edge and heat welding the top peripheral edge of the gusset vinyl layer to the peripheral edge of the top vinyl layer leaving an extension consisting of at least one of the top peripheral edge of the gusset vinyl layer and the peripheral edge of the top vinyl layer. The bottom peripheral edge of the gusset vinyl layer is welded to the peripheral edge of the bottom vinyl layer to enclose an air chamber. A cloth cover with a peripheral edge is provided. A heating pad with a peripheral edge is provided. A first edge of a first connector is stitched to the extension and a second edge of the first connector is stitched to the peripheral edge of the cloth cover and a first edge of a second connector is stitched to the peripheral edge of the heating pad and the second edge of the second connector is stitched to the extension. A support is provided in the mattress between the top and bottom vinyl layers and a way to conduct air to and from the air chamber is provided.

In another embodiment, a heated inflatable air bed is disclosed including a top vinyl layer with a peripheral edge, a bottom vinyl layer with a peripheral edge and a side gusset vinyl layer with a top and bottom peripheral edge. The peripheral edge of the top vinyl layer is welded to the top peripheral edge of the side gusset vinyl layer leaving an extension consisting of a section of at least one of the peripheral edge of the top vinyl layer and the top peripheral edge of the side gusset layer extending beyond the weld where a first edge of a connector is affixed. A heating pad having a peripheral edge is affixed to a second edge of the connector. The peripheral edge of the bottom vinyl layer is welded to the bottom peripheral edge of the side gusset vinyl layer forming an air chamber and there is a way to insert air into the air chamber penetrating a portion of the vinyl layers.

### BRIEF DESCRIPTION OF THE DRAWINGS

The invention can be best understood by those having ordinary skill in the art by reference to the following detailed description when considered in conjunction with the accompanying drawings in which:

FIG. 1 is a perspective view of the heated air mattress of the present invention.

FIG. 2 is a magnified view of the layers of the air mattress.

FIG. 3 is an elevational sectional view of the air mattress along lines 3-3 of FIG. 1.

FIG. 4 is an elevational sectional view of an alternate embodiment of the air mattress along lines 3-3 of FIG. 1.

FIG. 5 is an elevational sectional view of an alternate embodiment of the air mattress along lines 3-3 of FIG. 1.

FIG. 6 is an elevational sectional view of an alternate embodiment of the air mattress along lines 3-3 of FIG. 1.

FIG. 7 is an elevational sectional view of an alternate embodiment of the air mattress.

FIG. 8 is an elevational sectional view of an alternate embodiment of the air mattress along lines 3-3 of FIG. 1.

FIG. 9 is an elevational sectional view of an alternate embodiment of the air mattress along lines 3-3 of FIG. 1.

FIG. 10 is an elevational sectional view of an alternate embodiment of the air mattress along lines 3-3 of FIG. 1.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

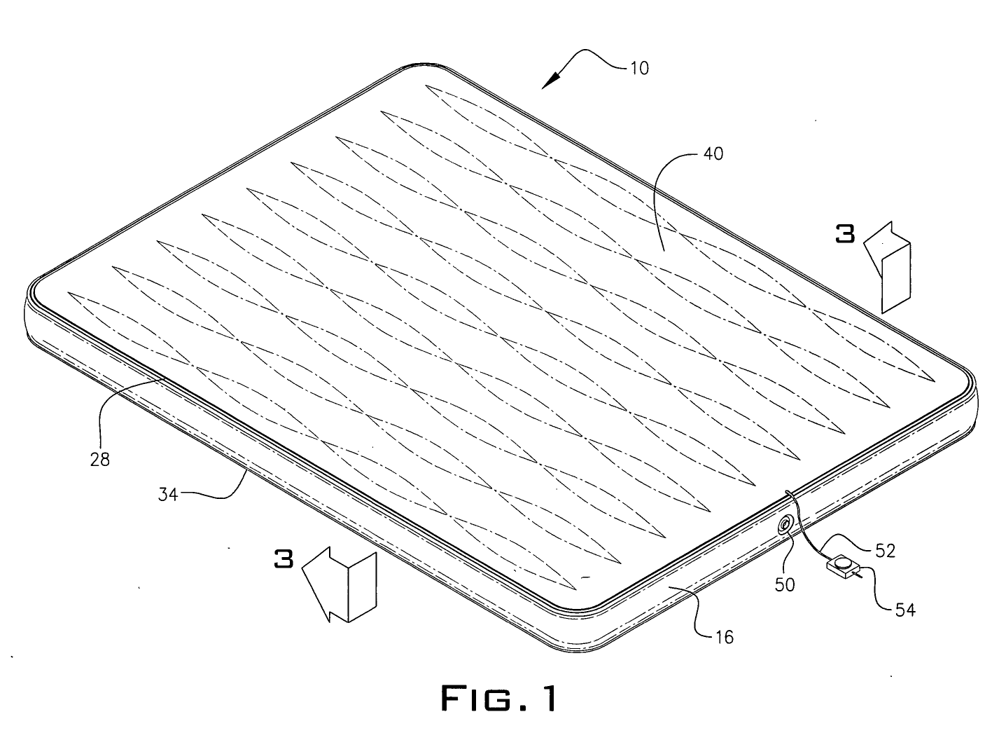

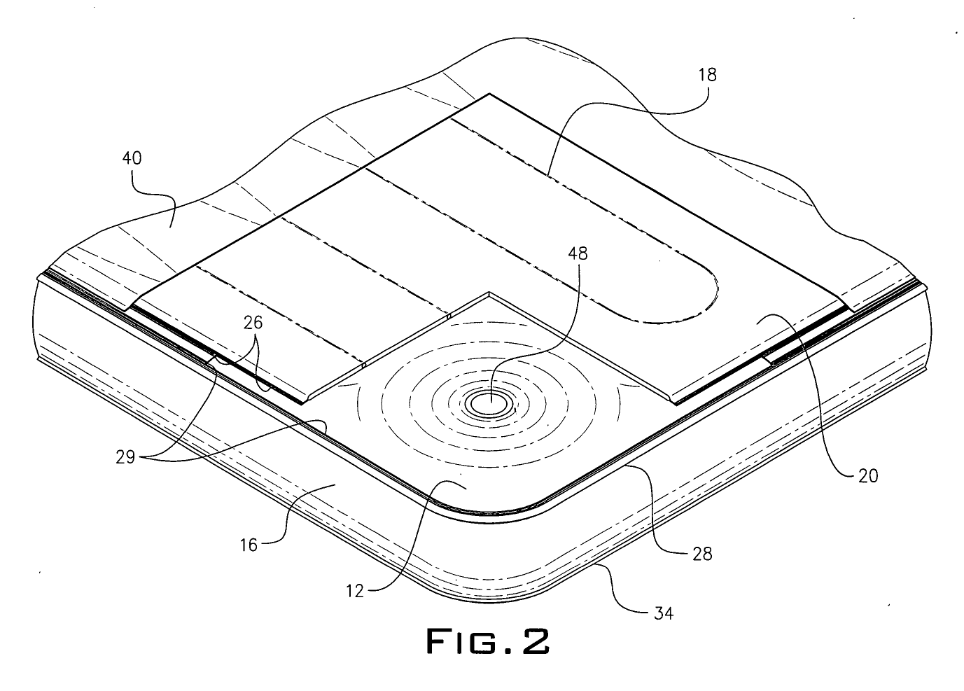

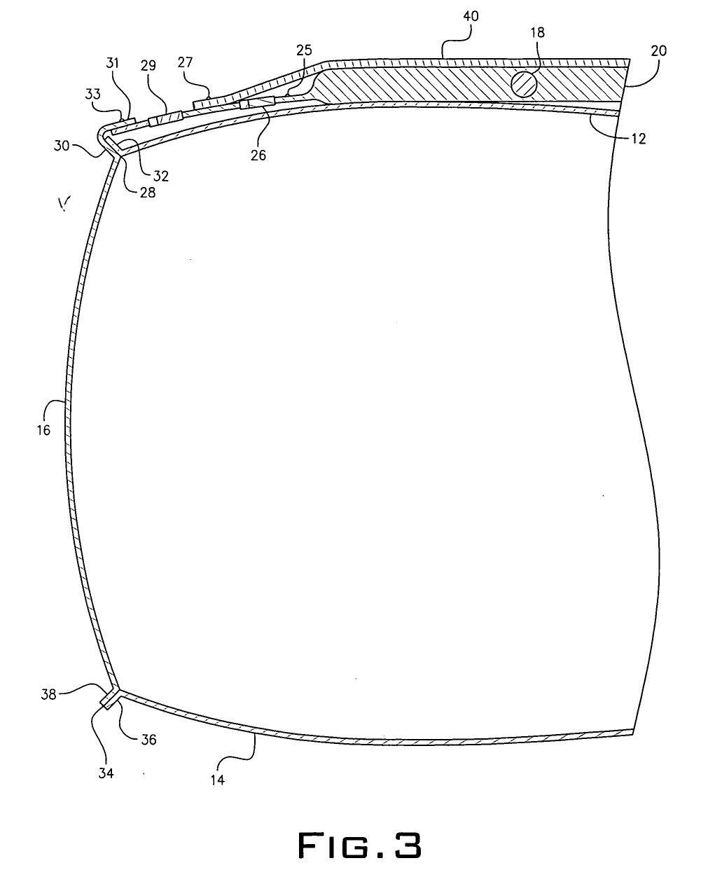

Referring to FIG. 1, FIG. 2 and FIG. 3, the heated inflatable air bed or mattress 10 has a top vinyl layer 12, a bottom vinyl layer 14 and a side gusset vinyl layer 16. A cloth cover 40 covers the top surface of the mattress 10. The cloth cover 40 encloses a heating pad 20. The heating pad 20 is generally constructed of a conductive material 18 usually in the form of a wire 18 encased in a carrier that is generally an insulative, fire-retardant cloth, plastic or rubber. The conductive material 18 emits heat when an electric current flows through it. In the prior art, the cloth cover and heating pad, either as separate components or as a single device, are affixed to the mattress top. This has proven to be less than optimal because during construction of a mattress of the prior art, high currents used to weld individual layers of vinyl emit electro-mechanical fields (EMF) that are transferred to the conductors within the heating pad potentially causing manufacturing defects. Furthermore, a failure of the heating pad during use of the prior art requires replacement of the entire mattress and heating pad combination. Furthermore, when the cloth cover is soiled, it must be cleaned while remaining attached to the mattress and cannot be placed in a washing machine. These limitations lead to the present invention providing for the removability of the cloth cover 40 and heating pad 20.

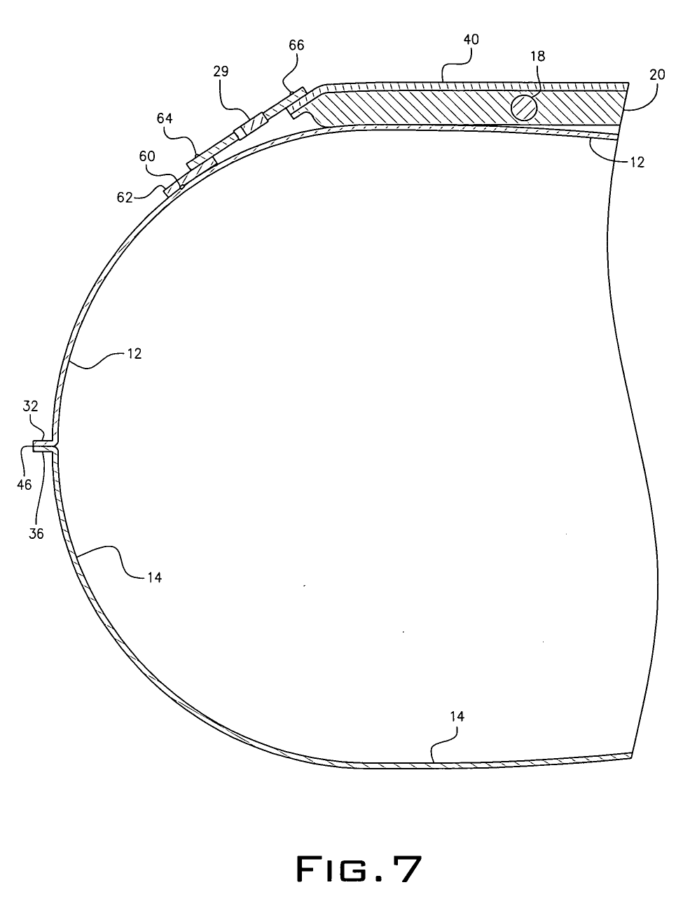

Referring to FIG. 2 and FIG. 3 and in all embodiments except as shown in FIG. 7, the peripheral edge 36 of the bottom vinyl layer 14 is affixed to the bottom peripheral edge 38 of the side gusset vinyl layer 16 by a weld 34. The weld or heat weld 34 is a method known in the industry for joining vinyl layers yielding a strong bond that is substantially airtight. A plurality of supports 48 are affixed between an inside surface of the top vinyl layer 12 and an inside surface of the bottom vinyl layer 14 by welding or other ways known in the art. These supports 48 help keep the mattress in shape when it is inflated, maintaining a desired distance between the top vinyl layer 12 and the bottom vinyl layer 14. There are many ways known in the industry to provide such support, each resulting in a slightly different mattress 10. For example, there is an I-beam support using vertical beams of vinyl attached by a heat weld to the top vinyl layer 12 and the bottom vinyl layer 14. Another example is a wave beam, similar to the I-beam using vertical waves of vinyl instead of vertical beams. Another example is an X-beam in which the top vinyl layer 12 is welded directly to the bottom vinyl layer 14. Another example uses a fabric cord attached to the top vinyl layer 12 and the bottom vinyl layer 14 to support the mattress 10 from over expanding when air is inserted. The present invention works with any way known to support the mattress and keep it in its desired shape when filled with air. Inflation of the air bed is accomplished by hand pumping or with an electric blower through fixture 50 as seen in FIG. 1. Air can be released from air bed 10 by opening a plug in fixture 50. As air enters fixture 50, the air chamber enclosed by the top, bottom and side vinyl layers inflates.

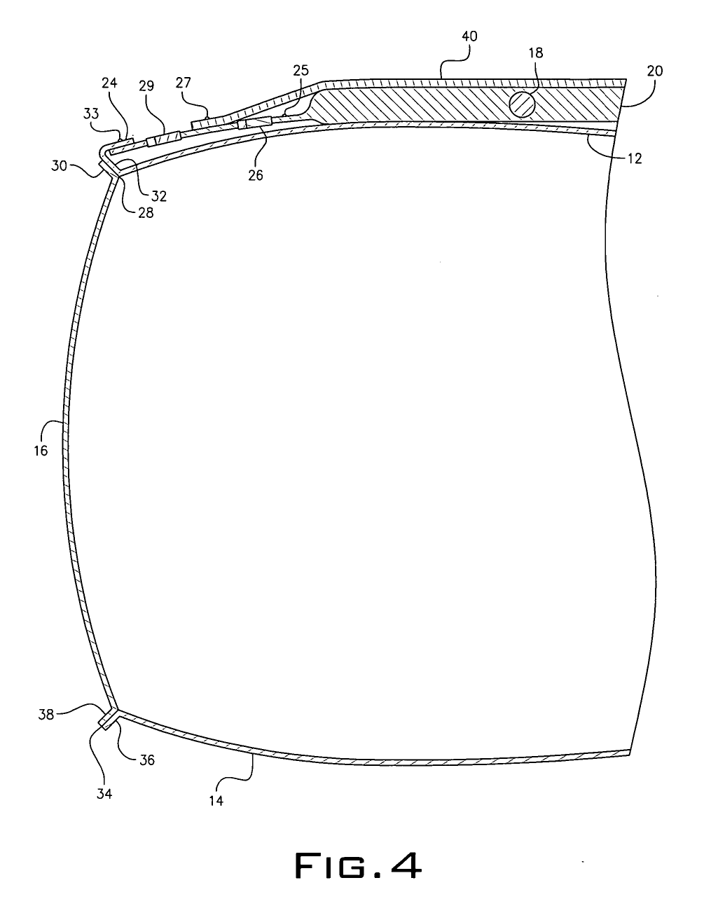

In one embodiment, referring to FIG. 2, FIG. 3 and FIG. 4, an excess vinyl material 31 extends beyond a weld 28 that attaches a peripheral edge 32 of the top vinyl layer 12 to a top peripheral edge 30 of the side gusset layer 16. In one embodiment, as shown in FIG. 3, the excess vinyl material 31 is part of the top peripheral edge 30 of the side gusset layer 16. In another embodiment, as shown in FIG. 4, the excess vinyl material 24 is part of the peripheral edge 32 of the top vinyl layer 12. In another embodiment, the excess vinyl material 31/24 is part of both the top peripheral edge 30 of the side gusset layer 16 and the peripheral edge 32 of the top vinyl layer 12.

The cloth cover 40 is affixed to a first edge of a zipper 29 by a weld or stitching 27. The second edge of the zipper 29 is affixed to the excess vinyl material 31 by stitching or a weld 33. In some embodiments, the heating pad is set between the cloth cover 40 and the top vinyl layer 12 before the zipper 29 is completely closed and held in place by closing the zipper 29, leaving enough of an opening for passage of an electrical conduit 52, connected to the conductors 18. In some embodiments, a rheostat 54 or other variable control known to the industry is provided in series with the electrical conduit 52 for adjusting the current flow through the conductors 18, thereby adjusting the heating levels.

In some embodiments, as shown in FIG. 3 and FIG. 4, the heating pad 20 is removably attached to the first zipper 29 and cloth cover 40. In this embodiment, the heating pad 20 is affixed to a first edge of a second zipper 26 by a weld or stitching 25 and the second edge of the second zipper 26 is affixed to the first zipper 29 and cloth cover 40 by a weld or stitching 27. Although shown as a single weld or stitching 27, in another embodiment, the first zipper 29 is affixed by one weld or stitching while the second zipper 26 is affixed by a second weld or stitching.

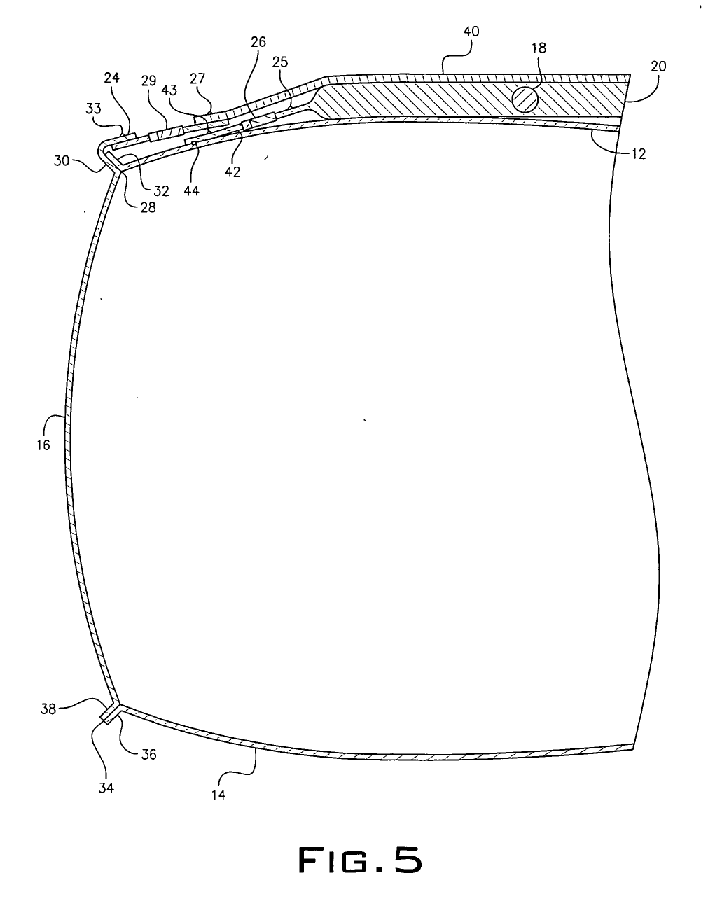

In some embodiments, as shown in FIG. 5, the heating pad 20 is removably attached to the top vinyl layer 12. In this embodiment, the heating pad 20 is affixed to a first edge of a second zipper 26 by a weld or stitching 25 and the second edge of the second zipper 26 is affixed to a vinyl strip 42 by a weld or stitching 43. The vinyl strip is affixed to the top surface of the top vinyl layer 12 by a weld 44.

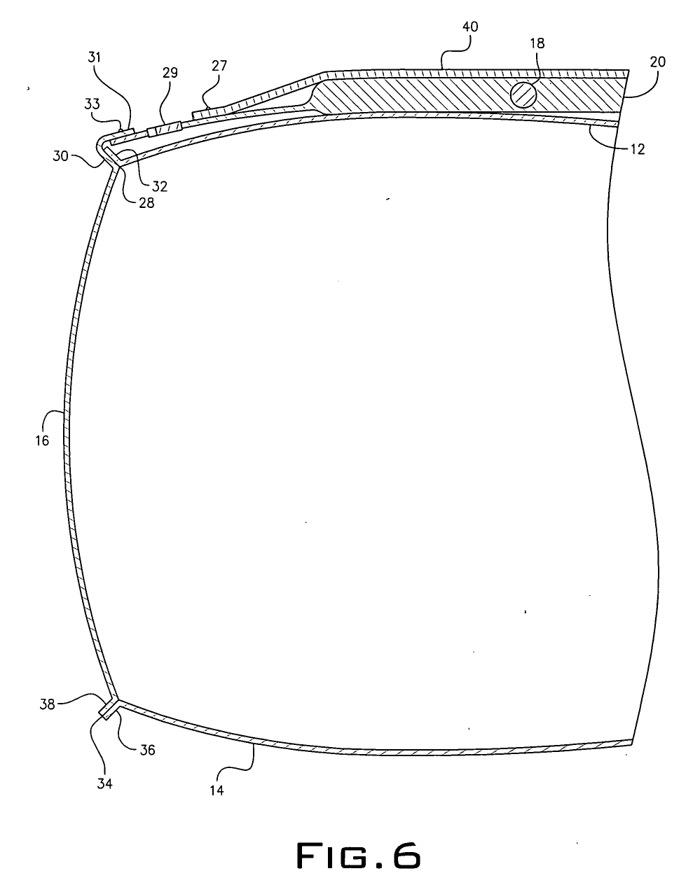

In some embodiments, as shown in FIG. 6, the heating pad 20 and cloth cover 40 are integrated and are removably attached to the mattress 10 by a zipper. In this embodiment, the heating pad 20 and cloth cover 40 are affixed to a first edge of a zipper 29 by a weld or stitching 27 and the second edge of the zipper 29 is affixed to the excess vinyl 31 by a weld or stitching 33. This embodiment provides for a single assembly consisting of the heating pad 20 and the cloth cover 40 that can be removed and machine washed. It has been shown that current heating pad 20 technologies allows for tens of wash cycles before degrading the performance of the heater. Furthermore, if the heating pad 20 is constructed of a cloth material with conductors embedded within the cloth, it can serve as both the heating pad 20 and the cloth cover 40, thereby eliminating the need for a separate cloth cover 20. In this embodiment, the zipper 29 would be attached to the heating pad 20 by stitches 27 and there would be no cloth cover 40.

Referring now to FIG. 7, an alternate embodiment of the mattress 10 is shown in which there is no side gusset and instead, the top vinyl layer 12 is affixed directly to the bottom vinyl layer 14 by welding a peripheral edge 32 of the top vinyl layer 12 to a peripheral edge 36 of the bottom vinyl layer 14 at weld point 46. In this embodiment, a vinyl strip 62 is affixed to the top vinyl layer 12 by a weld 60. The vinyl strip is affixed to a first edge of a zipper 29 by a weld or stitching 64. The second edge of the zipper 29 is stitched to the cloth cover 40 and the heating pad 20 by a weld or stitching 66. In another embodiment, a second zipper (not shown) connects the heating pad 20 to the cloth cover 40 as in previous embodiments.

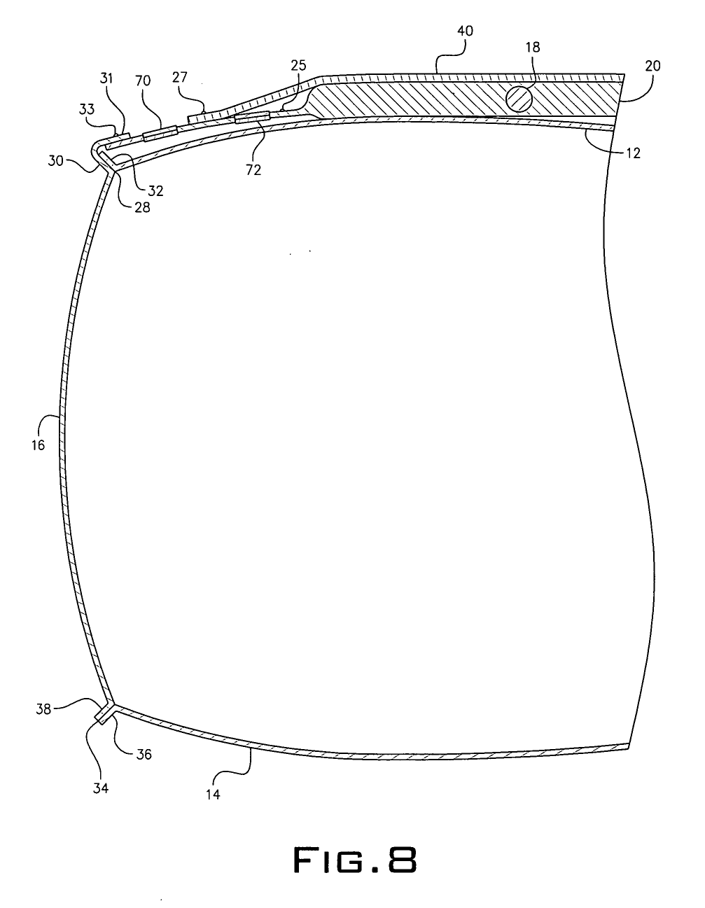

Referring now to FIG. 8, the heating pad 20 is removably attached by a first hook and loop 72 to cloth cover 40 and cloth cover 40 is removably attached to the mattress by a second hook and loop 70. In this embodiment, the heating pad 20 is affixed to a first edge of a first hook and loop 72 by a weld or stitching 25 and the second edge of the hook and loop 72 is affixed to a first edge of a second hook and loop 70 and cloth cover 40 by a weld or stitching 27. The second edge of the second hook and loop 70 is affixed to excess material 31 by a weld or stitching 33. Although shown as a single weld or stitching 27, in another embodiment, the first hook and loop 70 is affixed by a first weld or stitching and the second hook and loop 72 is affixed by a second weld or stitching.

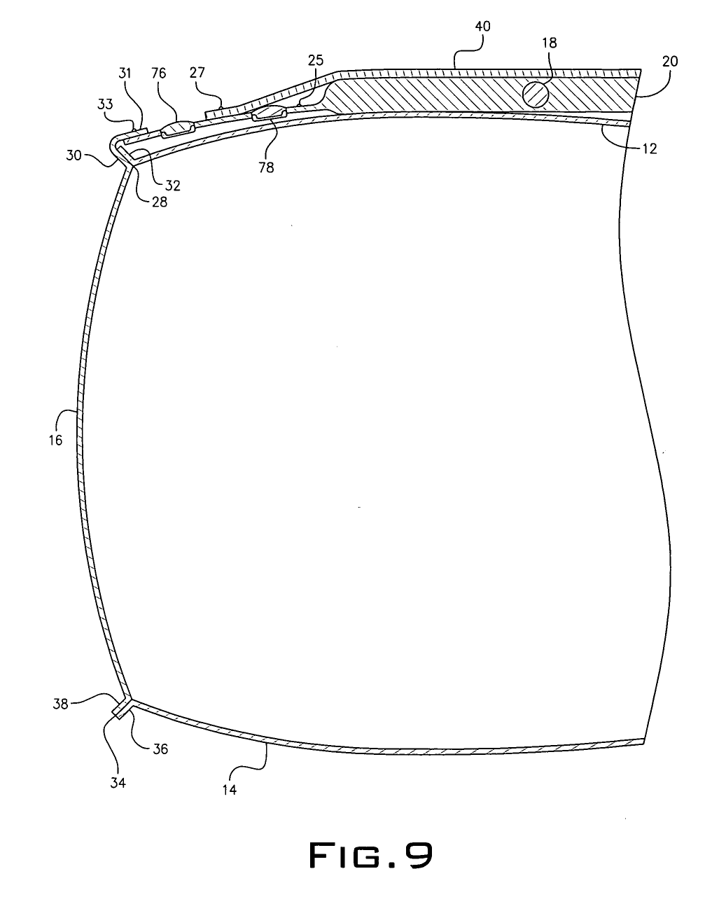

Referring now to FIG. 9, the heating pad 20 is removably attached by a first snap 78 to cloth cover 40 and cloth cover 40 is removably attached to the mattress by a second snap 76. In this embodiment, the heating pad 20 is affixed to a first edge of a first snap 78 by a weld or stitching 25 and the second edge of the first snap 78 is affixed to a first edge of a second snap 76 and the cloth cover 40 by a weld or stitching 27. The second edge of the second snap 76 is affixed to excess material 31 by a weld or stitching 33. Although shown as a single weld or stitching 27, in another embodiment, the first snap 76 is affixed by one weld or stitching to the cloth cover 40 and the second snap 78 is affixed to either the cloth cover 40 or the first snap 76 by a second weld or stitching.

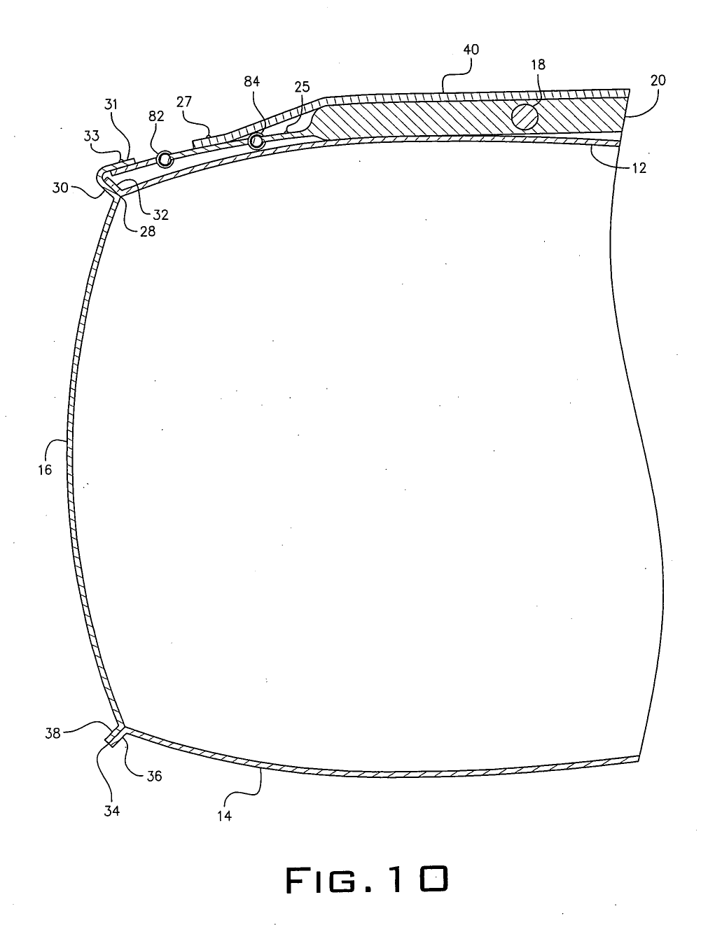

Referring now to FIG. 10, the heating pad 20 is removably attached by a first button and loop 84 to cloth cover 40 and cloth cover 40 is removably attached to the mattress by a second button and loop 82. In this embodiment, the heating pad 20 is affixed to a first edge of a first button and loop 84 by a weld or stitching 25 and the second edge of the first button and loop 84 is affixed to a first edge of a second button and loop 82 and to the cloth cover 40 by a weld or stitching 27. The second edge of the second button and loop 82 is affixed to excess material 31 by a weld or stitching 33. Although shown as a single weld or stitching 27, in another embodiment, the first button and loop 82 is affixed by a first weld or stitching to the cloth cover 40 and the second button and loop 84 is affixed to either the cloth cover 40 or the first button and loop 82 by a second weld or stitching.

Although the described embodiments of the present invention demonstrate homogeneous ways to attach the components to the mattress (for example, two zippers), it is intended and anticipated that any way of removably attaching these components can be used and that these ways can be mixed. As an example, a zipper removably attaches the heating pad 20 to the cloth cover 40 and a hook and loop removably attaches the cloth cover 40 to the mattress 10. Also, the present invention is not limited to any particular fluid being introduced between the layers of vinyl. Air is used as an example of one particular fluid, but the present invention works equally well with other gasses and liquids.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A heated inflatable air bed comprising:
a top vinyl layer having a peripheral edge;
a bottom vinyl layer having a peripheral edge;
a side gusset vinyl layer having a top and bottom peripheral edge;
the peripheral edge of the top vinyl layer welded to the top peripheral edge of the side gusset vinyl layer, whereas an extension consisting of a section of at least one of the peripheral edge of the top vinyl layer and the top peripheral edge of the side gusset layer extends beyond the weld and a first edge of a connection means is affixed to the extension;
a heating pad having a cloth cover and a peripheral edge, a second edge of the connection means affixed to the heating pad peripheral edge, the connection means being able to connect and disconnect;
the peripheral edge of the bottom vinyl layer welded to the bottom peripheral edge of the side gusset vinyl layer forming an air chamber; and
a means for inserting air into the air chamber penetrating a portion of the vinyl layers.

2. The heated inflatable air bed according to claim 1 further comprising a means between the top and bottom vinyl layers for supporting the air bed from expansion when inflated.

3. The heated inflatable air bed according to claim 2 wherein the means for supporting the air bed from expansion when inflated is selected from the group consisting of an I-beam support, a wave-beam support, an X-beam support and a fabric cord.

4. The heated inflatable air bed according to claim 1 wherein the connection means is a zipper and the zipper is affixed to the extension by stitching and the zipper is affixed to the heating pad by stitching.

5. The heated inflatable air bed according to claim 1 wherein the connection means is selected from the group consisting of a snap; a hook and loop; and a button and loop.

6. The heated inflatable air bed according to claim 1 further comprising an electrical conduit connectable to a source of electric current at one end and connected at a second end to a conductive material within the heating pad.

7. The heated inflatable air bed according to claim 6, wherein the electrical conduit is connected in series to a rheostat.

8. The heated inflatable air bed according to claim 1 wherein the means for inserting air into the air chamber includes an electric blower.

9. A heated inflatable air bed comprising:
a top vinyl layer having a peripheral edge;
a bottom vinyl layer having a peripheral edge;
a side gusset vinyl layer having a top and bottom peripheral edge;
the peripheral edge of the top vinyl layer welded to the top peripheral edge of the side gusset vinyl layer, whereas an extension consisting of a section of at least one of the peripheral edge of the top vinyl layer and the top peripheral edge of the side gusset layer extends beyond the weld and a first edge of a connection means is affixed to the extension;
a cloth cover having a peripheral edge, a second edge of the connection means affixed to the cloth cover peripheral edge, the connection means being able to connect and disconnect;
a heating pad disposed between the cloth cover and the top vinyl layer;
the peripheral edge of the bottom vinyl layer welded to the bottom peripheral edge of the side gusset vinyl layer forming an air chamber; and
a means for inserting air into the air chamber penetrating a portion of the vinyl layers.

10. The heated inflatable air bed according to claim 9 further comprising a second connection means connecting at least two peripheral edges of the heating pad to the top vinyl layer.

11. The heated inflatable air bed according to claim 9 further comprising a second connection means connecting at least two peripheral edges of the heating pad to the cloth cover.

12. The heated inflatable air bed according to claim 9 wherein the connection means is a zipper and the zipper is affixed to the extension by stitching and the zipper is affixed to the cloth cover by stitching.

13. The heated inflatable air bed according to claim 10 wherein the connection means is a zipper and the zipper is affixed to the extension by stitching and the zipper is affixed to the cloth cover by stitching and the second connection means is a second zipper and a first edge of the second zipper is affixed to the heating pad by stitching and a second edge of the second zipper is affixed to a strip of vinyl by stitching and the strip of vinyl is welded to the top vinyl layer.

14. The heated inflatable air bed according to claim 11 wherein the connection means is a zipper and a first edge of the zipper is affixed to the extension by stitching and a second edge of the zipper is affixed to the cloth cover by stitching and the second connection means is a second zipper and a first edge of the second zipper is affixed to the heating pad by stitching and a second edge of the second zipper is affixed to the cloth cover by stitching.

15. The heated inflatable air bed according to claim 14 wherein the same stitching is used to affix the second edge of the zipper to the cloth cover and the second edge of the second zipper to the cloth cover.

16. The heated inflatable air bed according to claim 9 wherein the connection means is selected from the group consisting of a snap; a hook and loop; and a button and loop.

17. The heated inflatable air bed according to claim 9 further comprising a means between the top and bottom vinyl layers for supporting the air bed from expansion when inflated.

18. The heated inflatable air bed according to claim 17 wherein the means for supporting the air bed from expansion when inflated is selected from the group consisting of an I-beam support, a wave-beam support, an X-beam support and a fabric cord.

19. The heated inflatable air bed according to claim 9 further comprising an electrical conduit connectable to a source of electric current at one end and connected at a second end to a conductive material within the heating pad.

20. The heated inflatable air bed according to claim 19, wherein the electrical conduit is connected in series to a rheostat.

21. The heated inflatable air bed according to claim 9 wherein the means for allowing air into the air chamber includes an electric blower.

22. A method of constructing a heated air bed comprising:
providing a top and a bottom vinyl layer having a peripheral edge;
providing a gusset vinyl layer having a top and bottom peripheral edge;
heat welding the top peripheral edge of the gusset vinyl layer to the peripheral edge of the top vinyl layer leaving an extension consisting of at least one of the top peripheral edge of the gusset vinyl layer and the peripheral edge of the top vinyl layer;
welding the bottom peripheral edge of the gusset vinyl layer to the peripheral edge of the bottom vinyl layer to enclose an air chamber;
providing a cloth cover with integrated electrical heating pad, the cloth cover having a peripheral edge;
stitching a first edge of a connection means to the extension;
stitching a second edge of the connection means to the peripheral edge of the cloth cover;
providing a means for supporting the air bed when inflated between the top and bottom vinyl layers; and
providing a means for conducting air to and from the air chamber.

23. The method according to claim 22 wherein an electrically operated air blower pumps air into the means for conducting air.

24. The method according to claim 22 further comprising:
providing an electrical conduit and connecting the conduit at a first end to the integrated electrical heating pad and at a second end to a source of electricity.

25. The method according to claim 22 wherein the connection means is selected from the group consisting of a zipper, a snap; a hook and loop; and a button and loop.

26. A method of constructing a heated air bed comprising:
providing a top and a bottom vinyl layer having a peripheral edge;
providing a gusset vinyl layer having a top and bottom peripheral edge;
welding the top peripheral edge of the gusset vinyl layer to the peripheral edge of the top vinyl layer leaving an extension consisting of at least one of the top peripheral edge of the gusset vinyl layer and the peripheral edge of the top vinyl layer;
welding the bottom peripheral edge of the gusset vinyl layer to the peripheral edge of the bottom vinyl layer to enclose an air chamber;
providing a cloth cover, the cloth cover having a peripheral edge;
providing a heating pad, the heating pad having a peripheral edge;
stitching a first edge of a first connection means to the extension;
stitching a second edge of the first connection means to the peripheral edge of the cloth cover;
stitching a first edge of a second connection means to the peripheral edge of the heating pad;
stitching the second edge of the second connection means to the cloth cover;
providing a means for supporting the air bed, when inflated between the top and bottom vinyl layers; and
providing a means for conducting air to and from the air chamber.

27. The method according to claim 26 wherein an electrically operated air blower pumps air into the means for conducting air.

28. The method according to claim 26 further comprising:
providing an electrical conduit and connecting the conduit at a first end to the heating pad and at a second end to a source of electricity.

29. The method according to claim 26 wherein the first connection means is selected from the group consisting of a zipper, a snap; a hook and loop; and a button and loop and the second connection means is selected from the group consisting of a zipper, a snap; a hook and loop; and a button and loop.

30. A heated inflatable air bed comprising:
a top vinyl layer having a peripheral edge;
a bottom vinyl layer having a peripheral edge;
a side gusset vinyl layer having a top and bottom peripheral edge;
the peripheral edge of the top vinyl layer welded to the top peripheral edge of the side gusset vinyl layer, whereas an extension consisting of a section of at least one of the peripheral edge of the top vinyl layer and the top peripheral edge of the side gusset layer extends beyond the weld and a first edge of a connection means is affixed to the extension;
a heating pad having a peripheral edge, a second edge of the connection means affixed to the heating pad peripheral edge, the connection means being able to connect and disconnect;
the peripheral edge of the bottom vinyl layer welded to the bottom peripheral edge of the side gusset vinyl layer forming an air chamber; and
a means for inserting air into the air chamber penetrating a portion of the vinyl layers.

31. The heated inflatable air bed according to claim 30 wherein the heating pad has at least one cloth surface, the cloth surface facing away from the top vinyl layer.

32. The heated inflatable air bed according to claim 30 further comprising a means between the top and bottom vinyl layers for supporting the air bed from expansion when inflated.

33. The heated inflatable air bed according to claim 32 wherein the means for supporting the air bed from expansion when inflated is selected from the group consisting of an I-beam support, a wave-beam support, an X-beam support and a fabric cord.

34. The heated inflatable air bed according to claim 30 wherein the connection means is a zipper and the zipper is affixed to the extension by stitching and the zipper is affixed to the heating pad by stitching.

35. The heated inflatable air bed according to claim 30 wherein the connection means is selected from the group consisting of a snap; a hook and loop; and a button and loop.

36. The heated inflatable air bed according to claim 30 further comprising an electrical conduit connectable to a source of electric current at one end and connected at a second end to a conductive material within the heating pad.

37. The heated inflatable air bed according to claim 36, wherein the electrical conduit is connected in series to a rheostat.

38. The heated inflatable air bed according to claim 30 wherein the means for inserting air into the air chamber includes an electric blower.
